(19) United States
(12) Patent Application Publication
(10) Pub. No.: US 2017/0192310 A1
(43) Pub. Date: Jul. 6, 2017

(54) PIXEL ELECTRODE AND LIQUID CRYSTAL DISPLAY PANEL

(71) Applicant: Shenzhen China Star Optoelectronics Technology Co., Ltd., Shenzhen City (CN)

(72) Inventor: Xinhui Zhong, Shenzhen City (CN)

(21) Appl. No.: 14/779,331

(22) PCT Filed: Jul. 24, 2015
(86) PCT No.: PCT/CN2015/085092

§ 371 Date: Sep. 23, 2015

(30) Foreign Application Priority Data
Jun. 25, 2015 (CN) 201510359964.X

(51) Int. Cl. G02F 1/1343; G02F 1/1362; G02F 1/1368

(52) U.S. Cl. CPC G02F 1/134309; G02F 1/13439; G02F 1/1368; G02F 1/136286; G02F 2201/123; G02F 2201/121

(57) ABSTRACT

The present invention provides a pixel electrode and a liquid crystal display panel. The pixel electrode comprises a frame (1), a plurality of first branch electrodes (21) which are parallel with one another and spaced with one another, and a plurality of second branch electrodes (22) which are parallel with one another and spaced with one another; the frame (1) comprises a plurality of frame electrodes which are connected with one another, and the plurality of first branch electrodes (21), the plurality of second branch electrodes (22) respectively appear 45° include angles with the plurality of frame electrodes, and the plurality of first branch electrodes (21) and the plurality of second branch electrodes (22) are orthogonal. The pixel electrode comprises two areas in one sub pixel, and utilizes design of not including the keel or one keel, and the active area in enlarged and the penetration rate of the liquid crystal panel is raised. In the liquid crystal display panel of the present invention, the pixel electrode comprises two areas in one sub pixel, and utilizes design of not including the keel or one keel, and the penetration rate is higher, and the demand to the backlight brightness is lower, and the usage power consumption is lower.

### FIELD OF THE INVENTION

The present invention relates to a display technology field, and more particularly to a pixel electrode and a liquid crystal display panel.

### BACKGROUND OF THE INVENTION

In recent years, the Thin Film Transistor-LCD (TFT-LCD) has been rapidly developed and applied widely. For the TFT-LCD in the mainstream market, three types, which respectively are Twisted Nematic (TN), Super Twisted Nematic (STN), In-Plane Switching (IPS) and Vertical Alignment (VA) can be illustrated. The VA liquid crystal display possesses extremely high contrast than the liquid crystal displays of other types, which can reach up to 4000-8000 in general. It has very wide application in large scale display, such as television or etc.

The reason why the VA liquid crystal display possesses extremely high contrast is that the liquid crystal molecules are vertically aligned to the substrate surface, and no phase difference exists, and light leakage is very small, and the dark state brightness is extremely small at the dark state without applying electricity. The lower the brightness at the dark state can be, the higher the contrast is according to the contrast calculation formula. For vertically aligning the liquid crystal molecules of the VA liquid crystal display to the substrate surface, it is demanded to implement vertical alignment treatment to the liquid crystal molecules. The most common way is to coat vertical alignment solution on specific areas of surfaces of the upper, lower substrates, and the alignment solution generally comprises a large amount of chemical solution NMP (N-methylpyrrolidone) and Polyimide (PI), and then to bake the substrates for a long period at high temperature (generally above 200 degrees) for curing the solvent in the alignment solution. Thus, PI alignment layers are formed on the surfaces of the substrates. As shown in FIG. 1, the traditional VA liquid crystal display comprises an upper glass substrate 100, a lower glass substrate 200 oppositely located to the upper glass substrate 100, a liquid crystal layer 400 sandwiched between the upper glass substrate 100 and the lower glass substrate 200, PI alignment layers 300 formed on a surface of the upper glass substrate 100 facing to the glass substrate 200 and a surface of the lower glass substrate 200 facing to the upper glass substrate 100. However, because the VA liquid crystal display utilizes vertical twist liquid crystals and the birefraction difference of the liquid crystal molecules is larger, the issue of the color shift under large view angle is more serious.

For earning better wide view angle property for the VA liquid crystal display panel to improve the color shift issue, the multi-domain VA (MVA) technology is commonly utilized, which is to divide a sub pixel into many districts and drive the liquid crystals in respective districts to lie down toward different directions as applying voltage. Thus, the watch results from respective directions can be equal. There are many methods for realizing the MVA technology. Please refer to FIG. 2, FIG. 3 and FIG. 4. One of the methods is to process onside of the ITO pixel electrode 520 to be a pozidriv pattern. The common electrode 510 is a plane electrode which has uniform thickness and is uninterruptedly continuous. With the special ITO pixel electrode pattern, the tilt electric field can induce the liquid crystal molecules 400 to fell down toward different directions.

FIG. 2 is a top view diagram of one side of a lower substrate 200 in an MVA liquid crystal display panel. 610 and 620 respectively are a scan line and a data line. One sub pixel is divided into four areas by the pixel electrode 520. The ITO pixel electrode 520 comprises a pozidriv keel 511 as being a main piece and a pattern of pixel electrode branches 512 respectively extending in directions of 45°, 135°, −45° and −135° from the pozidriv keel 511 relative to the horizontal direction with spaced slits. FIG. 3 is a sectional diagram of an MVA type liquid crystal display panel corresponding to A-A portion shown in FIG. 2. The pixel electrode 520 with slits is positioned on the flat lower passivation layer 600. The plane common electrode 510 is positioned on the flat upper passivation layer 601. The PI alignment layers 300 cover on the pixel electrode 520 and the common electrode 510.

According to the transmittance formula of the VA liquid crystal display panel:

$$T = \frac{1}{2} {sin}^{2} 2 {ΔΦsin}^{2} \frac{Γ}{2} \qquad ( 1 )$$

wherein T is the penetration rate, and Δφ is the included angle between the long axis of the liquid crystal and the polarizer, of which the efficiency is the maximum as the angle is 45°; Γ is the phase difference, i.e. the modulation result to the polarized light with the liquid crystal molecules driven by the electrical field.

The calculation formula of Γ is:

Γ=cos(a)*2π*Δn*d/λ (2)

wherein a is the included angle between the long axis of the liquid crystal and the normal line of the substrate, and the volume is determined according to the electrical fielding affecting the liquid crystal molecules, and d is the cell gap, and Δn is the refractivity difference of the long, short axes of the liquid crystal.

According to the penetration rate formula, in the four areas of the sub pixel, the pixel electrode 520 comprises a pattern of pixel electrode branches 512 respectively extending in directions of 45°, 135°, −45° and −135° relative to the horizontal direction with spaced slits (the direction of the upper, lower polarizers respectively are 0°, 90°). The long axes of the liquid crystal molecules will respectively fell down toward the directions of 45°, 135°, −45° and −135° relative to the horizontal direction. In the penetration rate formula sin² 2ΔΦ=1, the maximization of the penetration rate can be achieved.

However, the liquid crystal molecules 400 in the area corresponding to the (cross) keel 511 of the pixel electrode 520 as shown in FIG. 2 always cannot fell down as that the liquid crystal molecules in the areas corresponding to the pattern of the pixel electrode branches 512 with spaced slits fell down toward the directions of 45°, 135°, −45° and −135° relative to the horizontal direction. Thus, as shown in FIG. 5, the liquid crystal molecules 400 in the area corresponding to the (cross) keel 511 tilt toward 0° or fell down toward 90° to make sin² 2ΔΦ=0 in the penetration rate formula. The display is in an opaque state to cause the entire penetration rate of the liquid crystal display panel to descend.

### SUMMARY OF THE INVENTION

An objective of the present invention is to provide a pixel electrode, capable of solving the issue that the penetration rate is low because a portion of liquid crystal molecules at the main piece of pozidriv pixel electrode fall down toward the improper directions, to raise the penetration rate for reducing the demand to the backlight brightness of the liquid crystal display panel and lowering the cost and the usage power consumption.

Another objective of the present invention is to provide a liquid crystal display panel, of which the pixel electrode comprises two areas in one sub pixel, and utilizes design of not including the keel or one keel, and the penetration rate is higher, and the demand to the backlight brightness is lower, and the usage power consumption is lower.

For realizing the aforesaid objective, the present invention provides a pixel electrode, comprising a frame, a plurality of first branch electrodes which are parallel with one another and spaced with one another, and a plurality of second branch electrodes which are parallel with one another and spaced with one another;

the frame comprises a plurality of frame electrodes which are connected with one another, and the plurality of first branch electrodes, the plurality of second branch electrodes respectively appear 45° include angles with the plurality of frame electrodes, and the plurality of first branch electrodes and the plurality of second branch electrodes are orthogonal.

The frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrodes is larger than the lengths of the first frame electrode and the third frame electrode;

the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

The frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrodes is smaller than the length of the first frame electrode and the third frame electrode;

the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

The frame comprises a first frame electrode, and a second frame electrode orthogonally connected with the middle of the first frame electrode; a length of the second frame electrode is smaller than a length of the first frame electrode;

the plurality of first branch electrodes, the plurality of second branch electrodes are respectively positioned at one side of the first frame electrode and in two areas divided by the second frame electrode; the plurality of first branch electrodes and the plurality of second branch electrodes are symmetric relative to the second frame electrode.

A plurality of first, second electrode gaps are formed among the plurality of first, second branch electrodes; widths of the first, second electrode gaps are the same; widths of the first, second branch electrodes are the same.

Material of the pixel electrode is ITO.

The present invention further provides a pixel electrode, comprising a frame, a plurality of first branch electrodes which are parallel with one another and spaced with one another, and a plurality of second branch electrodes which are parallel with one another and spaced with one another;

the frame comprises a plurality of frame electrodes which are connected with one another, and the plurality of first branch electrodes, the plurality of second branch electrodes respectively appear 45° include angles with the plurality of frame electrodes, and the plurality of first branch electrodes and the plurality of second branch electrodes are orthogonal;

wherein the frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrode is larger than the lengths of the first frame electrode and the third frame electrode;

the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes;

wherein a plurality of first, second electrode gaps are formed among the plurality of first, second branch electrodes; widths of the first, second electrode gaps are the same; widths of the first, second branch electrodes are the same;

wherein material of the pixel electrode is ITO.

The present invention further provides a liquid crystal display panel, comprising an upper substrate, a lower substrate oppositely positioned to the upper substrate, a common electrode positioned at one side of the upper substrate facing the lower substrate, a pixel electrode positioned at one side of the lower substrate facing the upper substrate and a liquid crystal layer sandwiched between the common electrode and the pixel electrode;

the lower substrate comprises scan lines extending along the horizontal direction, data lines extending along the vertical direction and TFTs, and gates of the TFTs are coupled to the scan lines, sources are coupled to the data lines, and drains are coupled to the pixel electrode;

the pixel electrode, comprising a frame, a plurality of first branch electrodes which are parallel with one another and spaced with one another, and a plurality of second branch electrodes which are parallel with one another and spaced with one another;

the frame comprises a plurality of frame electrodes which are connected with one another, and the plurality of first branch electrodes, the plurality of second branch electrodes respectively appear 45° include angles with the plurality of frame electrodes, and the plurality of first branch electrodes and the plurality of second branch electrodes are orthogonal.

The frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrodes is larger than the lengths of the first frame electrode and the third frame electrode;

the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

The frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrodes is smaller than the length of the first frame electrode and the third frame electrode;

the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

The frame comprises a first frame electrode, and a second frame electrode orthogonally connected with the middle of the first frame electrode; a length of the second frame electrode is smaller than a length of the first frame electrode;

the plurality of first branch electrodes, the plurality of second branch electrodes are respectively positioned at one side of the first frame electrode and in two areas divided by the second frame electrode; the plurality of first branch electrodes and the plurality of second branch electrodes are symmetric relative to the second frame electrode.

The benefits of the present invention are: in the liquid crystal display panel of the present invention, the pixel electrode comprises two areas in one sub pixel, and utilizes design of not including the keel or one keel, and the active area in enlarged to solve the issue that the penetration rate is low because the liquid crystal molecules at the structure of the (cross) keel of pozidriv pixel electrode fall down toward the improper directions, to raise the penetration rate for reducing the demand to the backlight brightness of the liquid crystal display panel and lowering the cost and the usage power consumption. In the liquid crystal display panel of the present invention, the pixel electrode comprises two areas in one sub pixel, and utilizes design of not including the keel or one keel, and the penetration rate is higher, and the demand to the backlight brightness is lower, and the usage power consumption is lower.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a sectional diagram of a VA type liquid crystal display panel according to prior art;

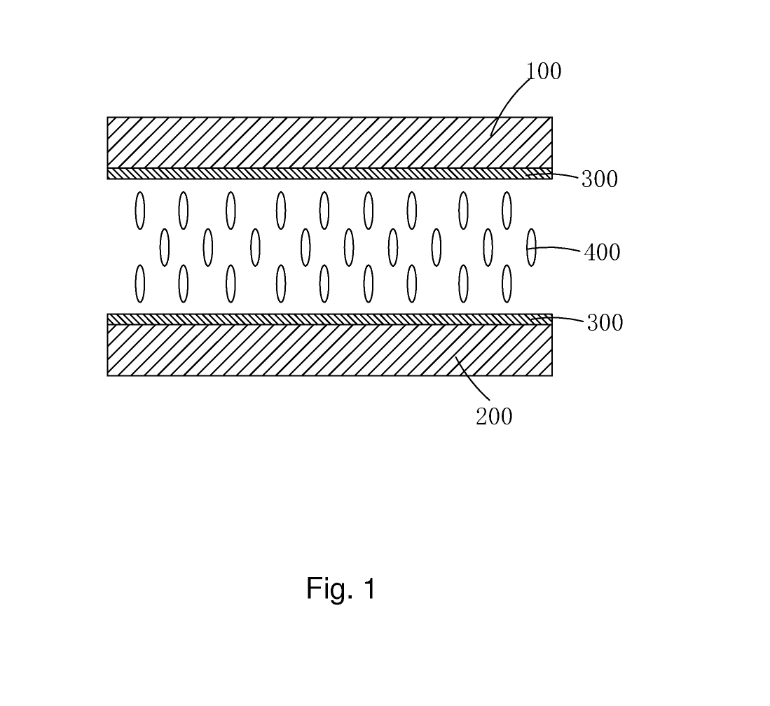

FIG. 2 is a top view diagram of one side of a lower substrate in an MVA type liquid crystal display panel according to prior art;

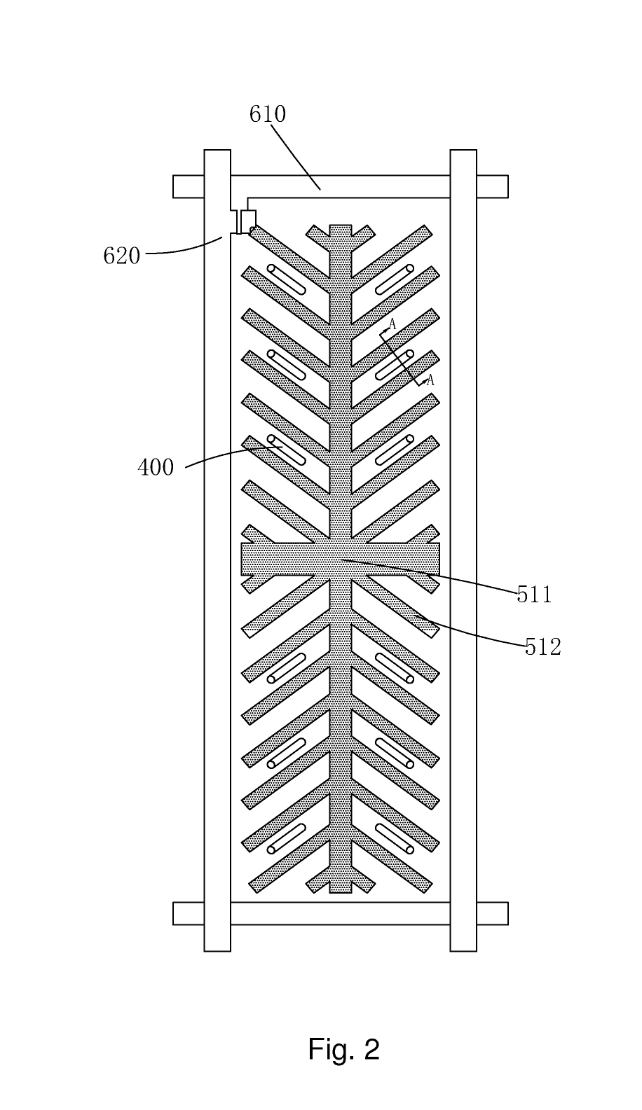

FIG. 3 is a sectional diagram of an MVA type liquid crystal display panel according to prior art corresponding to A-A portion shown in FIG. 2;

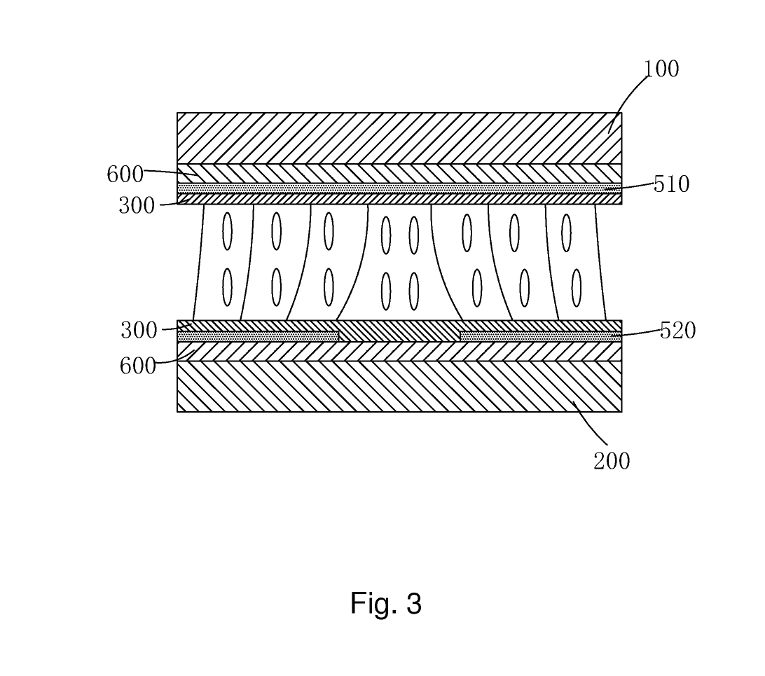

FIG. 4 is a felling direction diagram of liquid crystal molecules in the MVA type liquid crystal display panel shown in FIG. 2;

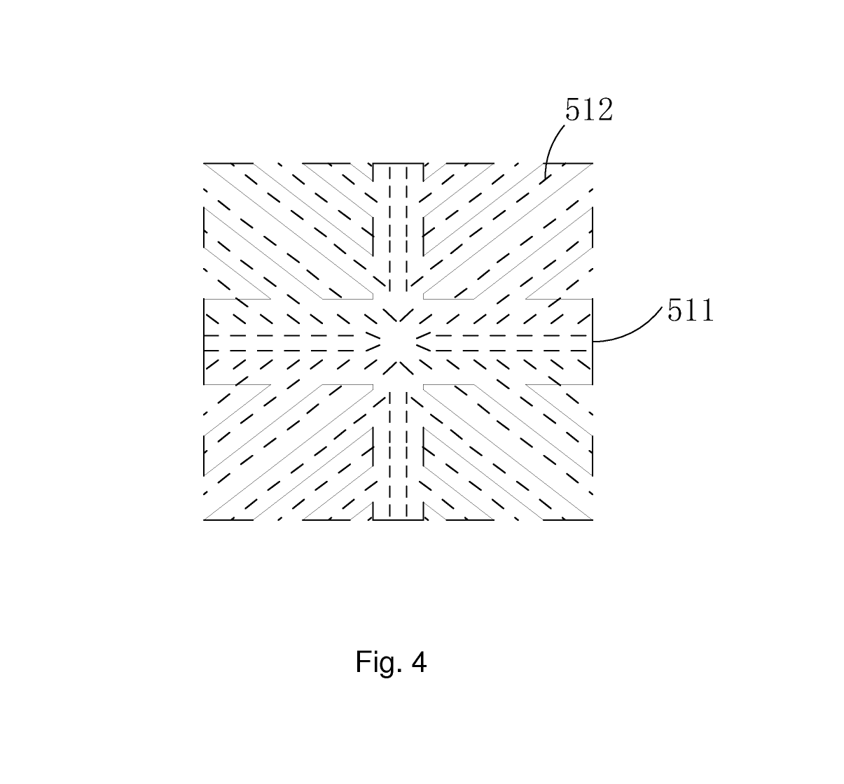

FIG. 5 is a top view diagram of a pixel electrode according to the first embodiment of the present invention;

FIG. 6 is a top view diagram of a pixel electrode according to the second embodiment of the present invention;

FIG. 7 is a top view diagram of a pixel electrode according to the third embodiment of the present invention;

FIG. 8 is a sectional structure diagram of a liquid crystal display panel according to the present invention;

FIG. 9 is the first top view diagram of one side of a lower substrate in the liquid crystal display panel according to the present invention;

FIG. 10 is the second top view diagram of one side of a lower substrate in the liquid crystal display panel according to the present invention;

FIG. 11 is the third top view diagram of one side of the lower substrate in the liquid crystal display panel according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

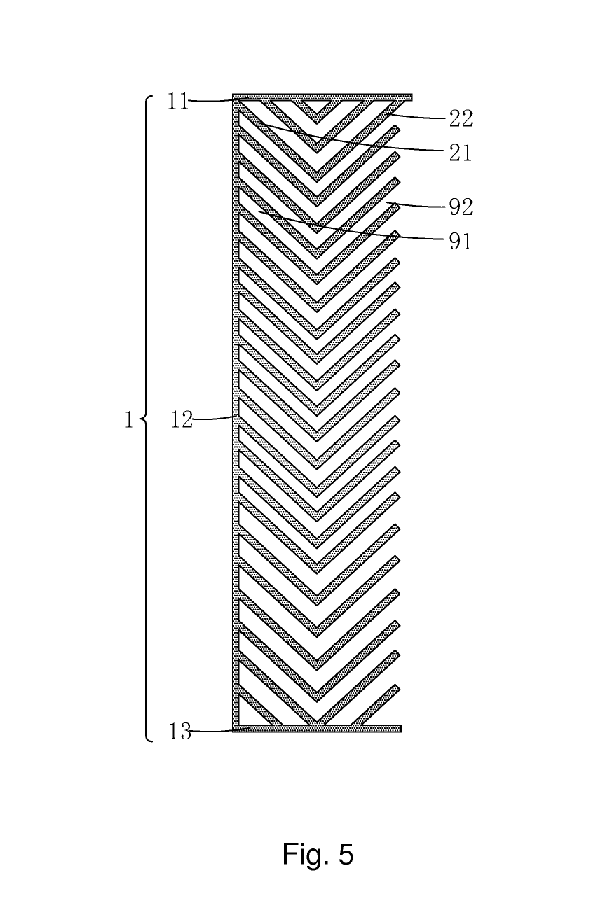

Please refer from FIG. 5 to FIG. 7. The present invention first provides a pixel electrode, comprising a frame 1, a plurality of first branch electrodes 21 which are parallel with one another and spaced with one another, and a plurality of second branch electrodes 22 which are parallel with one another and spaced with one another.

The frame 1 comprises a plurality of frame electrodes which are connected with one another, and the plurality of first branch electrodes 21, the plurality of second branch electrodes 22 respectively appear 45° include angles with the plurality of frame electrodes, and the plurality of first branch electrodes 21 and the plurality of second branch electrodes 22 are orthogonal.

FIG. 5 shows the first embodiment of the pixel electrode according to the present invention. The frame 1 comprises a first frame electrode 11 and a third frame electrode 13 which are mutually parallel, and a second frame electrode 12 which is orthogonally connected with end portions of the first frame electrode 11 and the third frame electrode 13; lengths of the first frame electrode 11 and the third frame electrode 13 are equal, and a length of the second frame electrode 12 is larger than the lengths of the first frame electrode 11 and the third frame electrode 13.

The plurality of first branch electrodes 21, the plurality of second branch electrodes 22 are positioned in an area surrounded by the first, second, third frame electrodes 11, 12, 13; the plurality of first branch electrodes 21 and the plurality of second branch electrodes 22 are symmetric relative to a midnormal of the first, third frame electrodes 11, 13.

Preferably, widths of the first, second, third frame electrodes 11, 12, 13 and widths of the first, second branch electrodes 21, 22 are the same.

In the first embodiment, the plurality of first branch electrodes 21, the plurality of second branch electrodes 22 respectively correspond to left, right, two areas in one sub pixel, and design of not including the keel is utilized, and the active area in enlarged to solve the issue that the penetration rate is low because the liquid crystal molecules at the structure of the (cross) keel of pozidriv pixel electrode fall down toward the improper directions, to raise the penetration rate for reducing the demand to the backlight brightness of the liquid crystal display panel and lowering the cost and the usage power consumption.

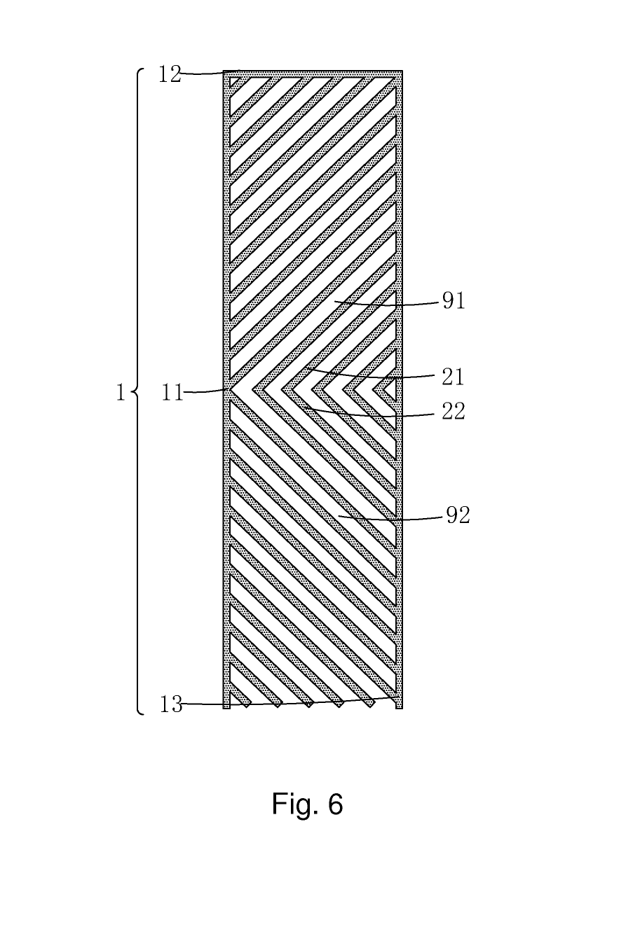

FIG. 6 shows the first embodiment of the pixel electrode according to the present invention. The frame 1 comprises a first frame electrode 11 and a third frame electrode 13 which are mutually parallel, and a second frame electrode 12 which is orthogonally connected with end portions of the first frame electrode 11 and the third frame electrode 13; lengths of the first frame electrode 11 and the third frame electrode 13 are equal, and a length of the second frame electrode 12 is smaller than the lengths of the first frame electrode 11 and the third frame electrode 13.

The plurality of first branch electrodes 21, the plurality of second branch electrodes 22 are positioned in an area surrounded by the first, second, third frame electrodes 11, 12, 13; the plurality of first branch electrodes 21 and the plurality of second branch electrodes 22 are symmetric relative to a midnormal of the first, third frame electrodes 11, 13.

Preferably, widths of the first, second, third frame electrodes 11, 12, 13 and widths of the first, second branch electrodes 21, 22 are the same.

In the second embodiment, the plurality of first branch electrodes 21, the plurality of second branch electrodes 22 respectively correspond to upper, lower, two areas in one sub pixel, and design of not including the keel is utilized, and the active area in enlarged to solve the issue that the penetration rate is low because the liquid crystal molecules at the structure of the (cross) keel of pozidriv pixel electrode fall down toward the improper directions, to raise the penetration rate for reducing the demand to the backlight brightness of the liquid crystal display panel and lowering the cost and the usage power consumption.

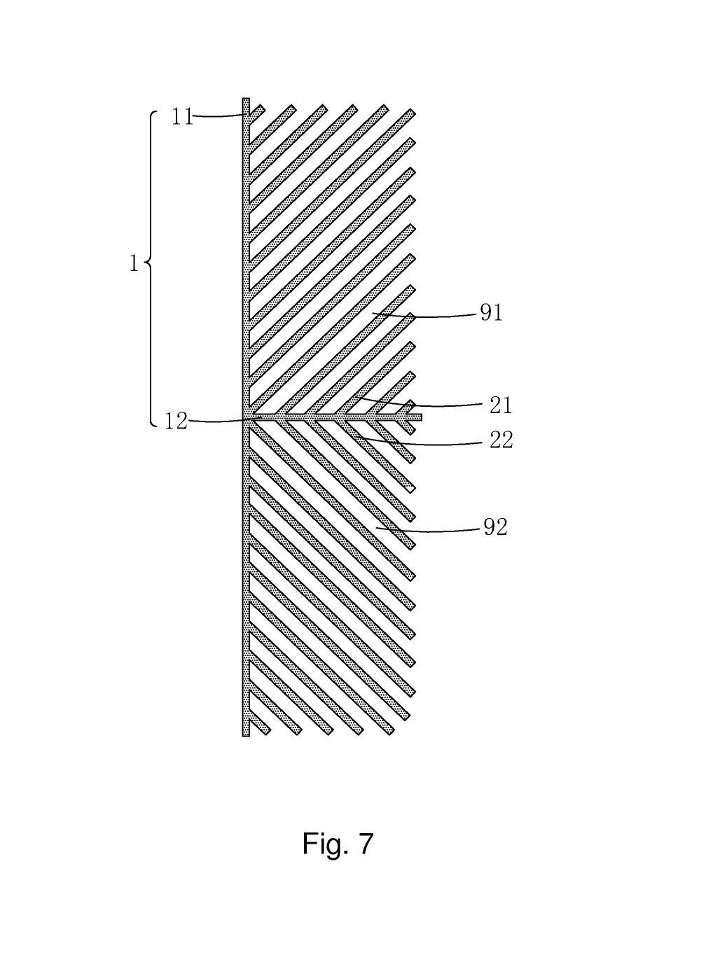

FIG. 7 shows the third embodiment of the pixel electrode according to the present invention. The frame 1 comprises a first frame electrode 11, and a second frame electrode 12 orthogonally connected with the middle of the first frame electrode 11; a length of the second frame electrode 12 is smaller than a length of the first frame electrode 11.

The plurality of first branch electrodes 21, the plurality of second branch electrodes 22 are respectively positioned at one side of the first frame electrode 11 and in two areas divided by the second frame electrode 12; the plurality of first branch electrodes 21 and the plurality of second branch electrodes 22 are symmetric relative to the second frame electrode 12.

Preferably, widths of the first, second frame electrodes 11, 12 and widths of the first, second branch electrodes 21, 22 are the same.

In the third embodiment, the plurality of first branch electrodes 21, the plurality of second branch electrodes 22 respectively correspond to upper, lower, two areas in one sub pixel, and the arrangement of the second frame electrode 12, i.e. design of the structure only one keel is utilized, and the active area in enlarged to solve the issue that the penetration rate is low because the liquid crystal molecules at the structure of the (cross) keel of pozidriv pixel electrode fall down toward the improper directions, to raise the penetration rate for reducing the demand to the backlight brightness of the liquid crystal display panel and lowering the cost and the usage power consumption.

Specifically, in the aforesaid first to third embodiment, a plurality of first, second electrode gaps 91, 92 are formed among the plurality of first, second branch electrodes 21, 22; widths of the first, second electrode gaps 91, 92 are the same; widths of the first, second branch electrodes 21, 22 are the same.

In the aforesaid pixel electrode, the pixel electrode comprises two areas in one sub pixel, and utilizes design of not including the keel or one keel, and the active area in enlarged to solve the issue that the penetration rate is low because the liquid crystal molecules at the structure of the (cross) keel of pozidriv pixel electrode fall down toward the improper directions, to raise the penetration rate for reducing the demand to the backlight brightness of the liquid crystal display panel and lowering the cost and the usage power consumption.

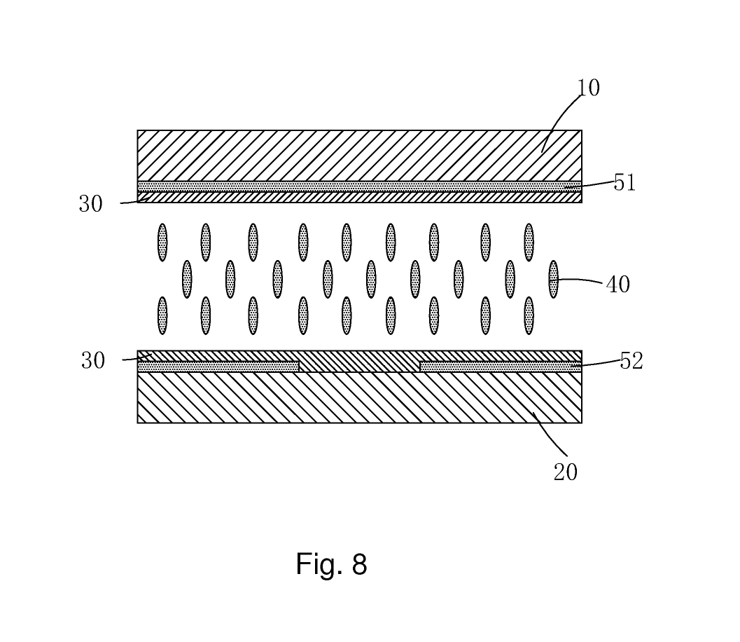

On the basis of the same inventive idea, the present invention further provides a liquid crystal display panel. Please refer to FIG. 8. The liquid crystal display panel of the present invention comprises: an upper substrate 10, a lower substrate 20 oppositely positioned to the upper substrate 10, a common electrode 51 positioned at one side of the upper substrate 10 facing the lower substrate 20, a pixel electrode 52 positioned at one side of the lower substrate 20 facing the upper substrate 10 and a liquid crystal layer 40 sandwiched between the common electrode 51 and the pixel electrode 52.

The lower substrate 20 comprises scan lines 61 extending along the horizontal direction, data lines 62 extending along the vertical direction and TFTs, and gates of the TFTs are coupled to the scan lines 61, sources are coupled to the data lines 62, and drains are coupled to the pixel electrode 52.

FIG. 8 further shows an alignment layer 30 covering the common electrode 51 and the pixel electrode 52 for implementing alignment to the liquid crystal layer 40. Certainly, it is possible to not to provide the alignment layer 30 but the polymer-stabilized vertical alignment (PSVA) is utilized to implement alignment to the liquid crystal layer 40.

Specifically, referring from FIG. 5 to FIG. 7, the pixel electrode 52 comprises a frame 1, a plurality of first branch electrodes 21 which are parallel with one another and spaced with one another, and a plurality of second branch electrodes 22 which are parallel with one another and spaced with one another.

The frame 1 comprises a plurality of frame electrodes which are connected with one another, and the plurality of first branch electrodes 21, the plurality of second branch electrodes 22 respectively appear 45° include angles with the plurality of frame electrodes, and the plurality of first branch electrodes 21 and the plurality of second branch electrodes 22 are orthogonal.

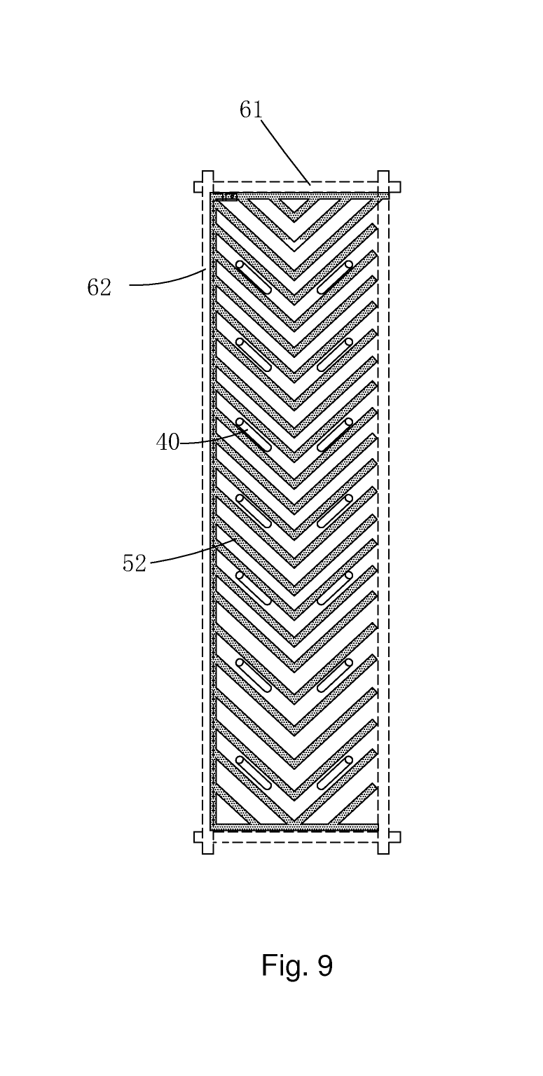

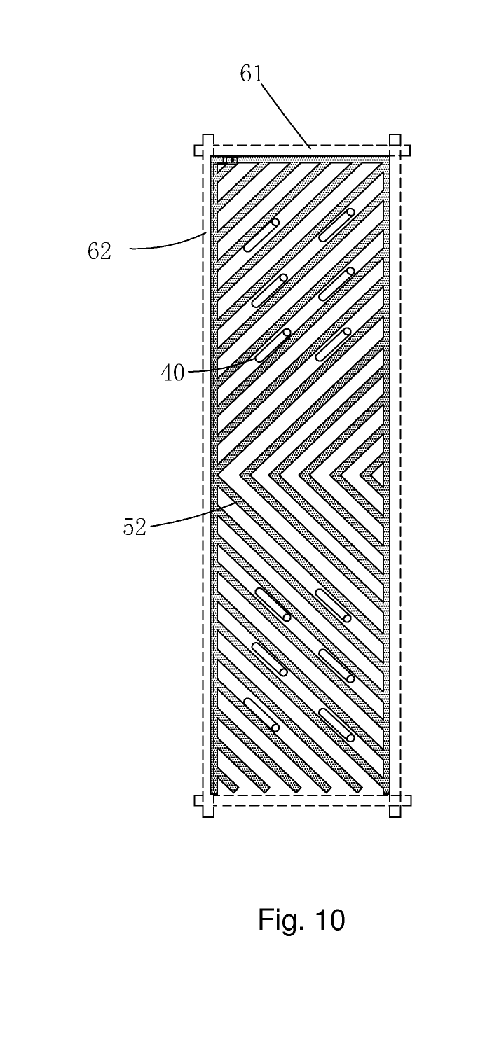

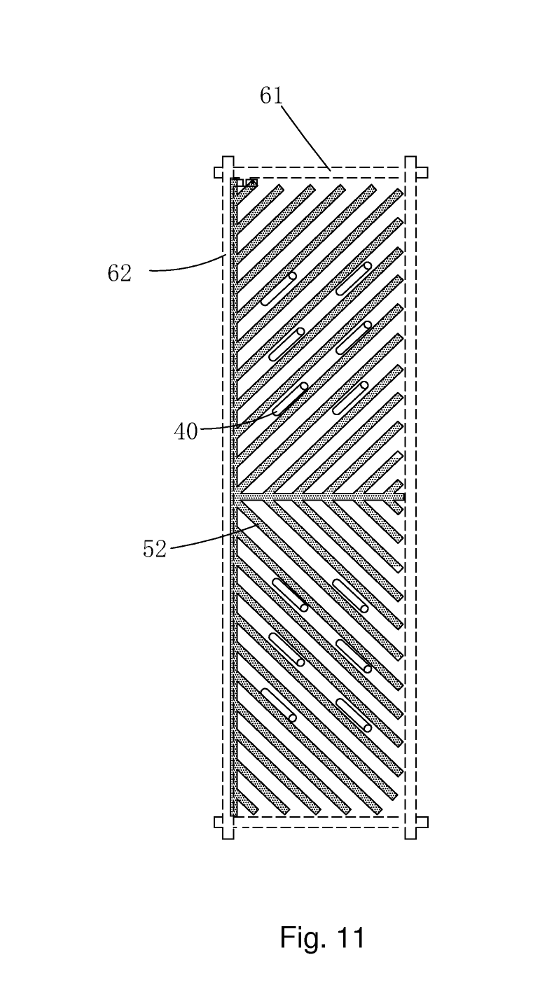

Please refer from FIG. 9 to FIG. 11. The pixel electrode 52 at one side of the lower substrate 20 can utilize any one structure of the first to third embodiment of the aforesaid pixel electrode. The repeated description is omitted here.

In the aforesaid liquid crystal display panel, the pixel electrode comprises two areas in one sub pixel, and design of not including the keel or one keel is utilized, and the penetration rate is higher, and the demand to the backlight brightness is lower, and the usage power consumption is lower.

In conclusion, in the liquid crystal display panel of the present invention, the pixel electrode comprises two areas in one sub pixel, and utilizes design of not including the keel or one keel, and the active area in enlarged to solve the issue that the penetration rate is low because the liquid crystal molecules at the structure of the (cross) keel of pozidriv pixel electrode fall down toward the improper directions, to raise the penetration rate for reducing the demand to the backlight brightness of the liquid crystal display panel and lowering the cost and the usage power consumption. In the liquid crystal display panel of the present invention, the pixel electrode comprises two areas in one sub pixel, and design of not including the keel or one keel is utilized, and the penetration rate is higher, and the demand to the backlight brightness is lower, and the usage power consumption is lower.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A pixel electrode, comprising a frame, a plurality of first branch electrodes which are parallel with one another and spaced with one another, and a plurality of second branch electrodes which are parallel with one another and spaced with one another;
the frame comprises a plurality of frame electrodes which are connected with one another, and the plurality of first branch electrodes, the plurality of second branch electrodes respectively appear 45° include angles with the plurality of frame electrodes, and the plurality of first branch electrodes and the plurality of second branch electrodes are orthogonal.

2. The pixel electrode according to claim 1, wherein the frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrode is larger than the lengths of the first frame electrode and the third frame electrode;
the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

3. The pixel electrode according to claim 1, wherein the frame comprises a first frame electrode and a third frame electrode which are mutually parallel, and a second frame electrode which are orthogonally connected with end portions of the first frame electrode and the third frame electrode; lengths of the first frame electrode and the third frame electrode are equal, and a length of the second frame electrode is smaller than the lengths of the first frame electrode and the third frame electrode;
the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

4. The pixel electrode according to claim 1, wherein the frame comprises a first frame electrode, and a second frame electrode orthogonally connected with the middle of the first frame electrode; a length of the second frame electrode is smaller than a length of the first frame electrode;
the plurality of first branch electrodes, the plurality of second branch electrodes are respectively positioned at one side of the first frame electrode and in two areas divided by the second frame electrode; the plurality of first branch electrodes and the plurality of second branch electrodes are symmetric relative to the second frame electrode.

5. The pixel electrode according to claim 1, wherein a plurality of first, second electrode gaps are formed among the plurality of first, second branch electrodes;
widths of the first, second electrode gaps are the same; widths of the first, second branch electrodes are the same.

6. The pixel electrode according to claim 1, wherein material of the pixel electrode is ITO.

7. A pixel electrode, comprising a frame, a plurality of first branch electrodes which are parallel with one another and spaced with one another, and a plurality of second branch electrodes which are parallel with one another and spaced with one another;
the frame comprises a plurality of frame electrodes which are connected with one another, and the plurality of first branch electrodes, the plurality of second branch electrodes respectively appear 45° include angles with the plurality of frame electrodes, and the plurality of first branch electrodes and the plurality of second branch electrodes are orthogonal;
wherein the frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrode is larger than the lengths of the first frame electrode and the third frame electrode;
the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes;
wherein a plurality of first, second electrode gaps are formed among the plurality of first, second branch electrodes; widths of the first, second electrode gaps are the same; widths of the first, second branch electrodes are the same;
wherein material of the pixel electrode is ITO.

8. A liquid crystal display panel, comprising an upper substrate, a lower substrate oppositely positioned to the upper substrate, a common electrode positioned at one side of the upper substrate facing the lower substrate, a pixel electrode positioned at one side of the lower substrate facing the upper substrate and a liquid crystal layer sandwiched between the common electrode and the pixel electrode;
the lower substrate comprises scan lines extending along the horizontal direction, data lines extending along the vertical direction and TFTs, and gates of the TFTs are coupled to the scan lines, sources are coupled to the data lines, and drains are coupled to the pixel electrode;
the pixel electrode, comprising a frame, a plurality of first branch electrodes which are parallel with one another and spaced with one another, and a plurality of second branch electrodes which are parallel with one another and spaced with one another;
the frame comprises a plurality of frame electrodes which are connected with one another, and the plurality of first branch electrodes, the plurality of second branch electrodes respectively appear 45° include angles with the plurality of frame electrodes, and the plurality of first branch electrodes and the plurality of second branch electrodes are orthogonal.

9. The liquid crystal display panel according to claim 8, wherein the frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrode is larger than the lengths of the first frame electrode and the third frame electrode;
the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

10. The liquid crystal display panel according to claim 8, wherein the frame comprises a first frame electrode and a third frame electrode which are mutually parallel, and a second frame electrode which is orthogonally connected with end portions of the first frame electrode and the third frame electrode; lengths of the first frame electrode and the third frame electrode are equal, and a length of the second frame electrode is larger than the lengths of the first frame electrode and the third frame electrode;
the plurality of first branch electrodes, the plurality of second branch electrodes are positioned in an area surrounded by the first, second, third frame electrodes; the plurality of first branch electrodes and the plurality of second branch electrodes are symmetric relative to a midnormal of the first, third frame electrodes.

11. The liquid crystal display panel according to claim 8, wherein the frame comprises a first frame electrode, and a second frame electrode orthogonally connected with the middle of the first frame electrode; a length of the second frame electrode is smaller than a length of the first frame electrode;
the plurality of first branch electrodes, the plurality of second branch electrodes are respectively positioned at one side of the first frame electrode and in two areas divided by the second frame electrode; the plurality of first branch electrodes and the plurality of second branch electrodes are symmetric relative to the second frame electrode.
